(19) United States
(12) Patent Application Publication
(10) Pub. No.: US 2026/0049839 A1
(43) Pub. Date: Feb. 19, 2026

(54) ROAD SURVEY DATA ACQUISITION WITH AUTOMATIC DETERMINATION OF START AND END POINTS FOR ROAD SECTIONS AND SEGMENTS

(71) Applicant: FNV IP B.V., Leidschendam (NL)

(72) Inventors: Patrick Oakes, Burlington (CA); Predrag Ivosev, Toronto (CA); Matthew John Connelly-Taylor, Paris (CA); Ryan John Fechney, Brisbane (AU); Bruce Keith Moore, San Diego, CA (US); Ryan Mumford Twilley, Lafayette, LA (US)

(73) Assignee: FNV IP B.V., Leidschendam (NL)

(21) Appl. No.: 18/806,154

(22) Filed: Aug. 15, 2024

(51) Int. Cl. G01C 21/00; G01S 7/4865; G01S 17/894

(52) U.S. Cl. CPC G01C 21/3815; G01C 21/3848; G01S 7/4865; G01S 17/894

(57) ABSTRACT

Described are systems and techniques for road surveying. Information indicative of a sequence of target road sections each comprising one or more road segments can be used to configure a vehicle to perform a road survey by traveling each target road section of the sequence. Data acquisition can be started from onboard sensors of the vehicle based on detecting a first trigger event where a current position of the vehicle is within a configured threshold distance from a first target road section of the sequence. Respective road survey data can be obtained for each road segment in each target road section of the sequence, and can comprise a subset of acquired data obtained from the onboard sensors between a corresponding start and end point automatically determined for the respective road segment based on detecting the occurrence of trigger events corresponding to the current vehicle position and/or heading.

### FIELD

Aspects of the present disclosure generally relate to road surveying. For example, aspects of the present disclosure are related to road surveying of a plurality of road segments with continuous data acquisition and automatic determination of corresponding start and end points for associating acquired road survey data to a respective one of the plurality of road segments. Unlocking insights from geodata, the present disclosure further relates to improvements in sustainability and environmental developments: together we create a safe and liveable world.

### BACKGROUND

A survey mechanism can refer to a device or system used for conducting surveys or collecting data in various fields such as land surveying, geographic information systems (GIS), construction, environmental monitoring, and scientific research. Traditional pavement surveying operations (e.g., also referred to as road surveying and/or road profiling, etc.) can be performed using a vehicle with an integrated or attached surveying mechanism with one or multiple onboard sensors. The surveying mechanism can be integrated on or within a vehicle and may be used to collect data regarding a topography and texture of pavement, as the vehicle is used to perform the road surveying by traveling (e.g., driving) upon the road surface of each of a plurality of road segments specified for inclusion in the road surveying operation(s). Road and pavement surveys can provide valuable insights into the need to repair cracks or potholes in the pavement.

In some examples, road surveys may be performed using multiple human operators. For example, a first operator may drive and control the vehicle to maneuver on the road surface(s) and/or road segments that are being surveyed. Concurrently, a second operator may also be located within the same road survey vehicle and can perform non-driving related tasks for the road survey. For example, the non-driving tasks of the second operator may include navigation, data quality verification, surveying system status evaluation, and various others. The non-driving tasks of the second operator within the road survey vehicle can include starting and stopping the data acquisition to mark the beginning and end, respectively, of the currently performed road survey. The non-driving tasks of the second operator within the road survey vehicle can additionally include identifying events within or during the road survey data acquisition, and adding corresponding event identifiers or indications to the collected or acquired road survey data. For example, the second operator can be tasked with manually identifying and marking the start and end of each road segment within the acquired data.

The number of tasks required by the second operator may detract from the data quality of the survey. In addition, having a multitude of tasks required between the first and second operators, may disadvantageously influence factors such as road safety or consistent data acquisition. There is thus a need for a method and system for improved data acquisition during road surveys.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In one illustrative example, a method can include: obtaining road surveying information indicative of a sequence of target road sections for a road survey, wherein each target road section comprises one or more road segments; configuring a vehicle to perform the road survey based on the vehicle traveling upon a respective surface corresponding to each target road section of the sequence of target road sections, wherein the vehicle includes onboard sensors; based on detecting the occurrence of a first trigger event corresponding to a current position of the vehicle being within a configured threshold distance from a first target road section of the sequence of target road sections, automatically starting data acquisition from the onboard sensors; and between a corresponding start point and a corresponding end point automatically determined for the respective road segment, performing the road survey to obtain respective road survey data for each respective road segment included in each target road section of the sequence of target road sections, the respective road survey data comprising a subset of acquired data from the data acquisition obtained from the onboard sensors between a corresponding start point and a corresponding end point automatically determined for the respective road segment based on detecting the occurrence of one or more of a second trigger event based on a calculated distance from the current position of the vehicle or a third trigger event based on a current heading of the vehicle.

In some aspects, the method can further include determining that the current position of the vehicle is beyond the configured threshold distance from an end point of a last target road section in the sequence of target road sections; and ending the data acquisition from the onboard sensors.

In some aspects, ending the data acquisition from the onboard sensors corresponds to completing the road survey for the sequence of target road sections indicated in the road surveying information.

In some aspects, determining the corresponding start point for each respective road segment includes: determining that an angular offset between the current heading of the vehicle and a pre-determined starting heading of the respective road segment is less than a configured heading threshold value; and determining that the current position of the vehicle is within a configured distance threshold from a pre-determined start location of the respective road segment.

In some aspects, determining the angular offset is less than the configured heading threshold value comprises the third trigger event; and determining the current position of the vehicle is within the configured distance threshold comprises the second trigger event.

In some aspects, determining the corresponding start point for each respective road segment is based on detecting the occurrence of the second trigger event and the third trigger event.

In some aspects, detecting the occurrence of the second trigger event is performed based on previously having detected the occurrence of the third trigger event.

In some aspects, detecting the occurrence of the second trigger event is skipped based on a determination the third trigger event has not occurred.

In some aspects, determining the corresponding end point for each respective road segment includes: determining that a calculated distance between the current position of the vehicle and a pre-determined ending location of the respective road segment is greater than a configured distance threshold value.

In some aspects, determining the calculated distance is greater than the configured distance threshold value comprises the second trigger event.

In some aspects, the corresponding start point for the respective road segment is determined based on a distance from the current position of the vehicle to a pre-determined starting location of the respective road segment being within a second configured threshold distance; and the corresponding end point for the respective road segment is determined based on a distance from the current position of the vehicle to a pre-determined ending location of the respective road segment exceeding the second configured threshold distance.

In some aspects, the road surveying information is indicative of a pre-determined ending location for each target road section in the sequence of target road sections; and the pre-determined ending location for each target road section is the same as the pre-determined ending location for a respective last road segment included in each target road section.

In some aspects, the current position of the vehicle and the current heading of the vehicle are obtained from one or more of the onboard sensors after starting the data acquisition to perform the road survey.

In some aspects, the current position of the vehicle and the current heading of the vehicle are obtained from an inertial navigation system (INS) included in the onboard sensors.

In some aspects, the vehicle is a road profiler vehicle or a road survey vehicle configured to perform the road survey based on the road surveying information.

In some aspects, the sequence of target road sections comprises a plurality of target road sections arranged in a sequential order for performing the road survey; and the road surveying information comprises a road network definition file.

In some aspects, the plurality of target road sections corresponds to a plurality of road segments, wherein a quantity of the plurality of road segments is greater than or equal to a quantity of the plurality of target road sections; and the road surveying information includes a plurality of polylines, and wherein each polyline of the plurality of polylines corresponds to a different road segment of the plurality of road segments.

In another illustrative example, an apparatus is provided. The apparatus includes at least one memory and at least one processor coupled to the at least one memory and configured to: obtain road surveying information indicative of a sequence of target road sections for a road survey, wherein each target road section comprises one or more road segments; configure a vehicle to perform the road survey based on the vehicle traveling upon a respective surface corresponding to each target road section of the sequence of target road sections, wherein the vehicle includes onboard sensors; based on detecting the occurrence of a first trigger event corresponding to a current position of the vehicle being within a configured threshold distance from a first target road section of the sequence of target road sections, automatically start data acquisition from the onboard sensors; and perform the road survey to obtain respective road survey data for each respective road segment included in each target road section of the sequence of target road sections, the respective road survey data comprising a subset of acquired data from the data acquisition obtained from the onboard sensors between a corresponding start point and a corresponding end point automatically determined for the respective road segment based on detecting the occurrence of one or more of a second trigger event based on a calculated distance from the current position of the vehicle or a third trigger event based on a current heading of the vehicle.

In another illustrative example, a non-transitory computer-readable storage medium comprising instructions stored thereon which, when executed by at least one processor, causes the at least one processor to: obtain road surveying information indicative of a sequence of target road sections for a road survey, wherein each target road section comprises one or more road segments; configure a vehicle to perform the road survey based on the vehicle traveling upon a respective surface corresponding to each target road section of the sequence of target road sections, wherein the vehicle includes onboard sensors; based on detecting the occurrence of a first trigger event corresponding to a current position of the vehicle being within a configured threshold distance from a first target road section of the sequence of target road sections, automatically start data acquisition from the onboard sensors; and perform the road survey to obtain respective road survey data for each respective road segment included in each target road section of the sequence of target road sections, the respective road survey data comprising a subset of acquired data from the data acquisition obtained from the onboard sensors between a corresponding start point and a corresponding end point automatically determined for the respective road segment based on detecting the occurrence of one or more of a second trigger event based on a calculated distance from the current position of the vehicle or a third trigger event based on a current heading of the vehicle.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 illustrates a front perspective view of an example survey mechanism including onboard sensors that may be used for performing a road survey by a vehicle, in accordance with some examples;

FIG. 2 illustrates a side schematic view of an example road survey system associated with a vehicle, in accordance with some examples;

FIGS. 3A and 3B illustrate respective side and top views of a schematic representation of an example road survey system associated with a vehicle, in accordance with some examples;

FIG. 4 is a diagram illustrating an example of data acquisition events corresponding to road surveying information indicative of a sequence of target road sections each comprising one or more road segments for a road survey, in accordance with some examples;

FIG. 5 is a diagram illustrating an example of data acquisition events corresponding to automatically determined corresponding start points and end points for each road segment of a plurality of road segments included in a sequence of target road sections for a road survey, in accordance with some examples;

FIG. 6 is a flow diagram illustrating an example of a process for road surveying, in accordance with some examples; and

FIG. 7 is a block diagram illustrating an example of a computing system for implementing certain embodiments of the present technology, according to embodiments of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Road surveying operations may be performed using specialized road surveying vehicles with dedicated or integrated road survey sensor arrays and mechanisms, and/or may be performed using non-dedicated vehicles with onboard sensors and/or externally coupled road survey sensor arrays and mechanisms. Road surveying operations can be used to support infrastructure management, for instance based on collecting detailed data about road and pavement conditions, which may be used to maintain and improve road networks in an efficient manner. For example, a road surveying vehicle (e.g., also referred to as vehicle-based road survey system or platform, a vehicle road survey system or platform, a road survey vehicle, a road profiler system or platform, and/or a road profiler vehicle, etc.) can be used to collect road survey data corresponding to or indicative of a topography and texture of pavement (e.g., the paved surface of a surveyed road, road section, road segment, etc.).

The road survey data can be obtained by the road survey vehicle as it drives, travels, or otherwise traverses the various road segments and sections that are the subject of a given road survey being performed. Road survey vehicles and platforms can include various onboard sensors and instruments for obtaining the road survey data. For example, the onboard sensors of a road survey vehicle and/or otherwise associated with performing road surveying operations can include, but are not limited to, one or more of Light Detection and Ranging (LiDAR) scanners, high-resolution cameras, inertial measurement units (IMUs), inertial navigation systems (INSs), Global Navigation Satellite System (GNSS) receivers, laser profilometers, radar or ground penetrating radar (GPR), etc.

As the road survey vehicle is driven along a road, the various onboard sensors are used to perform data acquisition. The road survey data that is acquired by the road survey vehicle during the road survey operations can include road survey data indicative of road geometry information, such as horizontal and vertical alignment, cross-sectional profiles, land widths and shoulder dimensions, etc. The road survey data may additionally be indicative of road surface condition information, such as surface roughness (e.g., international roughness index (IRI)), rutting depth and/or width, cracking (e.g., type, severity, extent, etc.), texture, etc. In some examples, the road survey data may be indicative of pavement structure information, including layer thickness, subsurface anomalies or defects, etc. In some examples, the road survey data may be indicative of various roadside features, such as signs, guardrails, or other assets, vegetation encroachment, etc. In some cases, the road survey data can be indicative of drainage features and corresponding drainage information, such as the location and condition of culverts and various other drainage structures or mechanisms.

Road survey data can be processed and used to create georeferenced datasets, which in some examples may be integrated into one or more Geographic Information Systems (GIS) for visualization and analysis by users. For example, road survey data can be used to perform comprehensive assessments of road network conditions, based on the objective and quantitative data captured during the road surveying operations and represented within the collected road survey data. Road survey data can be collected in an automated or semi-automated fashion, for example as a road survey vehicle is driven over a sequence of various road segments that are of interest for the particular road survey. The relatively high-speed of data collection provided by vehicle-based road surveying (e.g., relative to manual road surveying and other visual inspections, etc.) can increase the efficiency of operations, and may additionally minimize traffic disruptions.

As noted above, in many existing techniques and approaches to vehicle-based road surveying, road surveys may be performed using multiple human operators. For example, a first operator may drive and control the vehicle to maneuver on the road surface(s) and/or road segments that are being surveyed. Concurrently, a second operator may also be located within the same road survey vehicle, and can perform non-driving related tasks for the road survey. For example, the non-driving tasks of the second operator may include navigation, data quality verification, surveying system status evaluation, and various others. The non-driving tasks of the second operator within the road survey vehicle can include starting and stopping the data acquisition to mark the beginning and end, respectively, of the currently performed road survey. The non-driving tasks of the second operator within the road survey vehicle can additionally include identifying events within or during the road survey data acquisition, and adding corresponding event identifiers or indications to the collected or acquired road survey data. For example, the second operator can be tasked with manually identifying and marking the start and end of each road segment within the acquired data.

Reducing the operational complexity of vehicle-based road surveying operations may be beneficial. A vehicle-based road surveying system that can be safely and efficiently operated using only one human operator (e.g., a driver for the vehicle) may reduce the operational complexity and expense associated with performing road surveying operations or otherwise obtaining road survey data. It may additionally be beneficial to automate vehicle-based road surveying operations that are associated with the determining and generating metadata indicative of the corresponding start and end points (e.g., within a continuous data acquisition session of the road surveying operations) for each respective road segment that is included in the road survey, where a road segment represents the smallest discrete unit of continuous road or pavement surface that is to be surveyed.

Systems and techniques are described herein for vehicle-based road survey data acquisition with automatic determination of start and end points for road sections and road segments. Using the systems and techniques described herein, vehicle-based road surveying operations may be safely and efficiently performed using a single operator (e.g., driver) to drive the road survey vehicle during the road surveying operations. For example, sensor data from the same onboard sensors of the vehicle that are used for the data acquisition corresponding to the road survey may also be utilized, at least in part, for automatically detecting the occurrence of various trigger events for stopping and starting data acquisition at corresponding start and stop points of the various road segments, road sections, and/or collection sessions, etc., that are configured for the current road survey. In one illustrative example, the systems and techniques can obtain sensor data from the onboard sensors of the road survey vehicle that is indicative of a current position of the road survey vehicle. For example, the current vehicle position can be determined from a GNSS, INS, or other positioning system of the road survey vehicle. Sensor data may additionally be obtained indicative of a current heading or orientation of the road survey vehicle, for example in the form of accelerometer and/or gyroscopic sensor data obtained from the onboard sensors of the road survey vehicle. In some aspects, the position and heading information of the vehicle may be obtained from an INS of the road survey vehicle.

In some embodiments, automatically determining the corresponding start point and corresponding start point for data collection for each road segment (and in at least some examples, each target road section of a sequence of target road sections configured for the road surveying operations based on road surveying information (e.g., configuration information for the road survey and/or road surveying operations performed by the road survey vehicle). The automatically determined corresponding start and end point information for each road segment of the plurality of road segments configured for the road survey can be seen to increase or otherwise improve an accuracy associated with the resulting road survey data that is obtained. For example, using the GNSS-based current vehicle position and/or the INS-based current vehicle heading, the systems and techniques can accurately identify when the vehicle begins traveling over a particular road segment (and therefore collecting respective road survey data that corresponds to that particular road segment), and can generate an indication that data acquisition for the particular road segment has started. Similarly, the systems and techniques can accurately identify when the vehicle ceases to travel over the particular road segment (and therefore ceases collecting the respective road survey data that corresponds to that particular road segment), and can generate an indication that the data acquisition for the particular road segment has ended.

Automatically detected and determined start and stop points for the road survey data acquisition corresponding to each road segment can eliminate or reduce the need to perform manual post-processing of the collected road survey data to correlate the collected data to the individual road segments. The automatic start and stop point detection can additionally reduce or eliminate the need to perform repeated survey operations over a portion of the road segments (e.g., eliminate the need to re-survey road segments where a human operator marked the start point too late and/or marked the end point too early, etc.) In some aspects, the systems and techniques can increase the efficiency of road survey operations by collecting less road survey data during the road survey. For instance, in existing techniques that use two human operators in the road survey vehicle, the manually marked start and stop points of a road segment are often initiated earlier than the true start point (e.g., in an attempt to avoid a ‘missed’ marker point where the manually marked start point is later than or after the true start point of the road segment), and are ended later than the true end point (e.g., in an attempt to avoid another type of ‘missed’ marker point where the manually marked end point is prior to or before the true end point of the road segment), etc.

Further aspects are described below with respect to the figures.

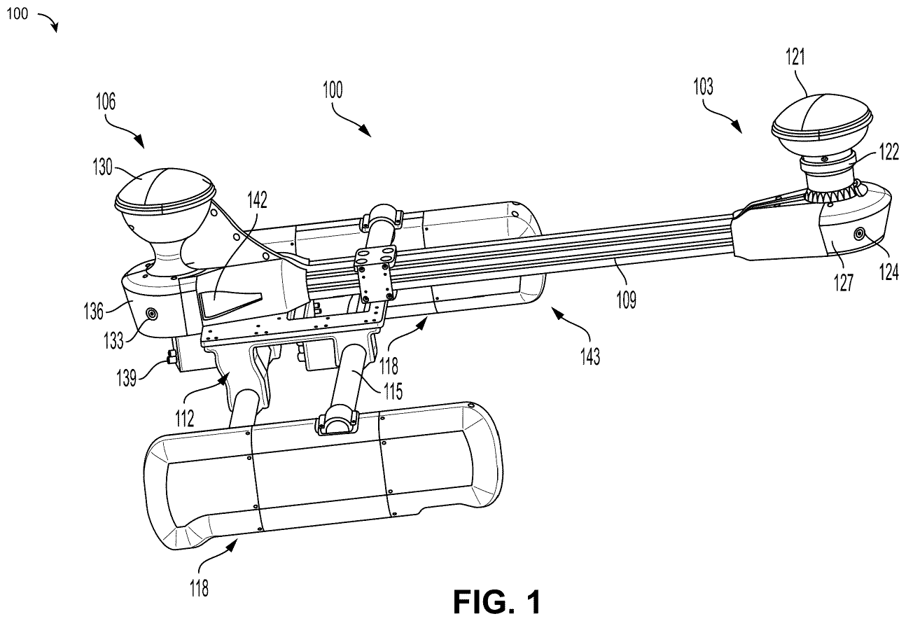

FIG. 1 illustrates a front perspective view of an example survey mechanism including onboard sensors that may be used for performing a road survey by a vehicle, in accordance with some examples. In some examples, the survey mechanism can also be referred to herein as a vehicle-based road survey system or platform, a vehicle road survey system or platform, a road survey vehicle, a road profiler system or platform, and/or a road profiler vehicle, etc. In some examples, the survey mechanism can be implemented or provided as a portable and detachable survey mechanism that can be removably attached and detached from a vehicle configured to perform one or more road surveys. In some cases, by allowing a detachable coupling, the survey mechanism can be implemented without a dependence on a particular vehicle chassis or required integration into a dedicated vehicle for performing the road surveys. In other examples, the survey mechanism may be implemented with a non-detachable, permanent, and/or semi-permanent coupling or integration to a road survey vehicle. For example, the survey mechanism may in some cases be combined or integrated with a particular vehicle chassis or dedicated vehicle for performing the road surveys.

The road survey mechanism can include a plurality of onboard sensors used by the road profiler vehicle to perform a road survey. For example, one or more three-dimensional sensor can be included, where the one or more three-dimensional sensors are positionally rigid with respect to their location(s) on the frame of the road survey mechanism, such that the location of the sensor is known within the system. One or more three-dimensional sensors can be coupled to the frame and obtain a three-dimensional topography of the road and the surrounding environment upon which the vehicle travels. A navigation system is provided to measure the position of the mechanism, and an inertial measurement unit is provided to measure an orientation of the mechanism, each at a given time. The mechanism is therefore able to accurately measure a three-dimensional topography of a road and the surrounding environment for and during the performing of the one or more road surveys configured for the road profiler vehicle (e.g., road survey vehicle).

As shown in FIG. 1, a road survey mechanism 100 can includes a front pod 103 and a rear pod 106 with a beam 109 extending between the front pod 103 and the rear pod 106. The road survey mechanism 100 can further include a frame 112 with at least one crossbar 115, and with at least one three-dimensional sensor 118 coupled to the crossbar 115. The three-dimensional sensor(s) 118 can be included in a plurality of onboard sensors of the road survey mechanism 100, and can be used to measure a three-dimensional topography of a surface upon which the vehicle is traveling (e.g., a road, one or more road sections, one or more road segments (where each road section comprises one or multiple road segments), etc.). The front pod 103 can include a front antenna 121 and a Light Detection and Ranging (LiDAR) sensor 122. The front pod 103 may include one or more front pod camera(s) 124 and a front cover 127 surrounding the front pod camera(s) 124. Similarly, the rear pod 106 can include a rear antenna 130 and rear pod camera(s) 133, with a rear cover 136 surrounding the rear pod camera(s) 133. The at least one camera 124, 133 can be coupled to the frame 112.

An inertial measurement unit (IMU) 139 can be coupled to the rear pod 106 for measuring an orientation of the road survey mechanism 100 continuously, periodically, aperiodically, intermittently, etc. Based on the road survey mechanism 100 being coupled or otherwise attached to a road survey vehicle, the inertial measurements and/or orientation information of the road survey mechanism 100 can be treated as being the same as or equal to the corresponding inertial measurements and/or orientation information of the road survey vehicle, and/or can otherwise be used to calculate or derive such information for the road survey vehicle that includes the road survey mechanism 100 and IMU 139. In some examples, the IMU 139 can be included in an inertial navigation system (INS) of the road survey vehicle and/or the road survey mechanism 100. The IMU 139 may include one or more inertial sensors, including accelerometers, gyroscopes and/or gyro sensors, magnetic sensors, orientation or heading sensors, etc.

In some cases, the rear pod 106 can be rigidly coupled to the beam 109, which itself is rigidly coupled to the front pod 103, which is rigidly coupled to the frame 112, to comprise the entire rigid system of the mechanism 100. A vent 142 can be defined within the rear cover and can communicate with the rear pod camera(s) 133 to permit air flow over the rear pod camera(s) 133. The front pod 103 can provide data more easily captured from the front portion of a vehicle through the various components of the front pod 103. The front pod 103 can include a front pod common reference point (e.g., such as a virtual point at a base of the LiDAR sensor 122). In some examples, a rear common reference point can be a vertical axis that extends through the vertical axis of the rear antenna 130. The front common reference point can be the virtual point at which the LiDAR sensor 122 treats as its origin for purposes of computing x, y, and z values of measured objects. The LiDAR sensor 122 and front antenna 121 can be aligned along a vertical axis that extends through this point to simplify the data processing steps when digitally recreating the surface and surrounding topography. Similarly, the rear common reference point can be a point on a vertical line that extends through the vertical axis of the rear antenna 130. In some embodiments, the rear common reference point is a point on the cover of the inertial measurement unit 139. A laser 148, inertial measurement unit 139, and rear antenna 130 can all be aligned along a plane that extends through this line. By establishing these two known points, the road survey mechanism 100 can determine the exact position of the front pod 103 and rear pod 106 during the measurement process and measure other values with respect to these common reference points. By maintaining two common reference points, this also allows the beam 109 to be different lengths depending on the specific project.

The front antenna 121 and/or rear antenna 130 can be an antenna associated with a navigation system (e.g., a vehicle navigation system, an onboard inertial navigation system (INS), etc.) that measures and outputs a global position of the road survey mechanism 100 and/or the road survey vehicle to which the road survey mechanism 100 is coupled. To this end, the front antenna 121 and/or the rear antenna 130 can individually or collectively act as a navigation system coupled to the frame 112 and can be configured to measure and output a position of the road survey mechanism 100 at a given time. For example, the navigation system can be a global positioning system (GPS), a global navigation satellite system (GNSS), an inertial navigation system (INS), a radio frequency identification (RFID) navigation system, a dead reckoning navigation system, a visual odometry system, a celestial navigation system, a beacon-based navigation system, a laser-based navigation system, and/or a magnetic navigation system, etc.

The LiDAR sensor 122 can be coupled to the frame 112 and configured to detect a distance from the LiDAR sensor 122 to an object. The LiDAR can use eye-safe laser beams to “see” the world in three dimensions. For example, the LiDAR sensor 122 emits laser pulses towards objects in its vicinity and measures the time it takes for the pulses to reflect back to the LiDAR sensor 122 after reaching the objects. By precisely timing the return of these pulses, the LiDAR sensor 122 calculates the distance to each object, creating a detailed three-dimensional map of the environment. The LiDAR sensor 122 is also able to output distance measurement data so that the road profiler or road survey system can correlate the distance measurement data with images captured by the front pod camera 124 or rear pod camera 133. In this manner, the distance to the images (e.g., objects represented therewithin) can be determined. Additionally, the LiDAR sensor 122 can capture the intensity of the returned laser light, providing information about the objects' reflectivity or material properties.

The front pod camera(s) 124 and the rear pod camera(s) 133 can be coupled to the frame 112 and can face a substantially horizontal direction that is substantially parallel to the surface upon which the vehicle is traveling. The front pod camera(s) 124 and rear pod camera(s) 133 can be any camera capable of capturing all or part of an image. For example, the front pod camera 124 can be a digital single-lens reflex (DSLR) camera, a mirrorless camera, a compact digital camera, a panoramic camera, a thermal imaging camera, a multispectral camera, or a hyperspectral camera. The choice of camera depends on factors such as the desired image resolution, spectral sensitivity, field of view, and environmental conditions in which the surveying mechanism operates. By employing a suitable camera, the front pod camera(s) 124 facilitates the acquisition of high-quality visual data essential for precise surveying and mapping applications. The rear pod camera(s) 133 can be the same type of camera as the front pod camera 124 or, in some embodiments, is a different camera. Further, as will be described in more detail below, the front pod camera 124 and rear pod camera 133 can be a plurality of cameras angularly separated to capture a wide range of images, in some cases 360 degrees of images.

The frame 112 can act as the structural backbone of the mechanism 100. For example, the beam 109 can be considered part of the frame 112 in some embodiments, because the front pod 103 couples to the rear pod 106 via the beam 109. The crossbars 115, beam 109, and the frame 112 can be rigid so that locational accuracy can be confirmed within the data collected by the mechanism 100. In some cases, the mechanism 100 can include a coupling mechanism 143 configured to detachably couple the frame 112 to a vehicle (e.g., a vehicle configured for performing the road survey, also referred to as a road survey vehicle or a road profiler vehicle, etc.). The coupling mechanism 143 can be, for example, a clamp system, magnetic attachment, suction device, mechanical fasteners such as bolts or screws, snap-fit connectors, locking pins, hook-and-loop fasteners, adhesive bonding, quick-release mechanisms, or any combination thereof. The coupling mechanism 143 may incorporate adjustable or telescoping features to accommodate different vehicle dimensions, as well as built-in safety locks or release triggers to enhance security and ease of detachment when required. The coupling mechanism 143 also may include shock and vibration damping components. These shock and vibration components decouple the dynamics of the vehicle from the survey mechanism 100 to achieve better data collection precision.

The inertial measurement unit 139 can be coupled to the frame and configured to measure and output an orientation of the road survey mechanism 100 at a given time. For example, the inertial measurement unit 139 can measure and report one or more (or all) of acceleration, angular rate, and magnetic field data, enabling tasks such as motion tracking, navigation, and stabilization. In examples where the road survey mechanism 100 is implemented or provided with multiple three-dimensional sensors 118, the inertial measurement unit 139 can output data permitting the angle between the plurality of three-dimensional sensors 118 to be determined. For example, the inertial measurement unit 139 can dynamically measure an angle between the plurality of three-dimensional sensors 118 during operation of the mechanism 100. The inertial measurement unit 139 can be any device capable of measuring the inertia of the vehicle and/or the mechanism 100 and an angle thereof. For example, the inertial measurement unit 139 can be an Inertial Measurement Unit (IMU) incorporating accelerometers, gyroscopes, and magnetometers to precisely determine the vehicle's linear and angular motion in three-dimensional space. Alternatively, the inertial measurement unit 139 can include MEMS (Micro-Electro-Mechanical Systems) sensors, fiber optic gyroscopes, or piezoelectric sensors, each offering unique advantages in terms of size, accuracy, and power consumption for effectively monitoring and analyzing the vehicle's dynamics and orientation.

The navigational system and inertial measurement unit 139 can be designed to determine precise spatial and orientation data in a global reference frame. Specifically, these features can collectively deliver coordinates in three dimensions (X, Y, Z), orientation data (heading, roll, pitch), and time synchronization, all referenced to the navigation system framework. The orientation components—heading, roll, and pitch—are ascertained based on local-level measurements, correlating with gravitational forces at the specific location of measurement. The system utilizes a defined geometric relationship, encompassing both the coordinates (X, Y, Z) in the frame 112 and rotational angles around these three axes. Understanding this geometric configuration, the system is capable of translating the sensor-specific data into the global context. As noted above, the three-dimensional sensor 118 can be coupled to the frame 112 in a positionally rigid manner. That is, the three-dimensional sensor 118 is coupled to the frame such that the three-dimensional sensor 118 defines a predetermined position relative to the frame 112. The three-dimensional sensor 118 faces a surface upon which the vehicle is traveling in a substantially vertical direction and is configured to measure a three-dimensional topography of the surface. In some examples, and as shown, multiple three-dimensional sensors 118 are provided for broader collection of surface data during and corresponding to the road survey performed using a road survey vehicle with the road survey mechanism 100 attached or integrated thereto. For example, the three-dimensional sensors 118 can be positioned a fixed distance apart from one another on opposite sides of the mechanism and their field of scan can overlap slightly to ensure full coverage of the surface while also allowing the overlap region to act as a calibration region. The three-dimensional sensor(s) 118 can determine the three-dimensional topography of the surface through laser line triangulation.

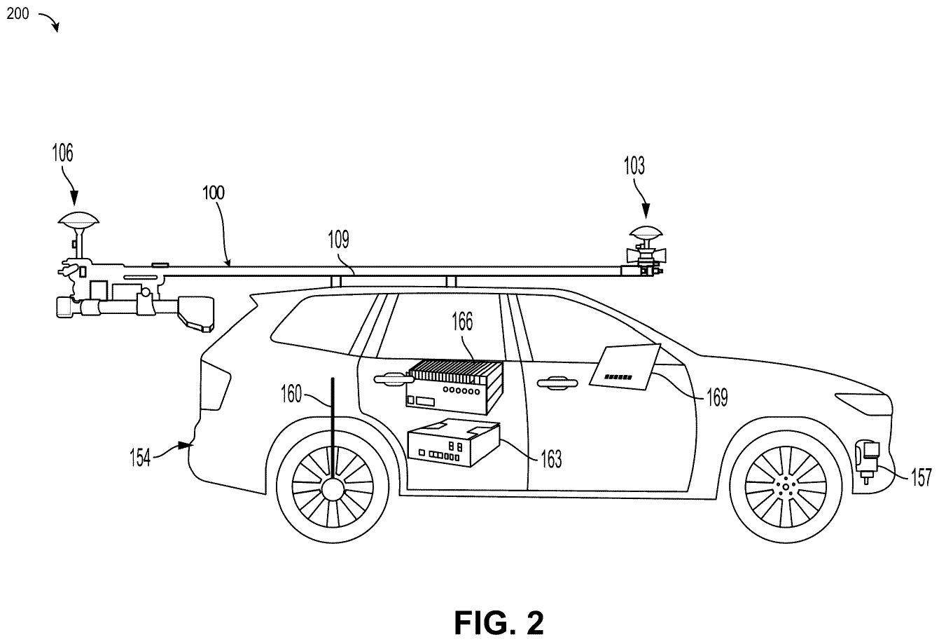

FIG. 2 illustrates a side schematic view of an example road survey system 200, which in some examples can comprise a vehicle 154 with the road survey mechanism 100 of FIG. 1 attached thereto. The vehicle 154 may also be referred to as a road survey vehicle, a road profiler vehicle, and/or a road profiler, etc. As shown, the road survey mechanism 100 is detachably coupled to a vehicle 154. The internal electrical components associated with the road survey mechanism 100 are shown in schematic form. In some examples, the vehicle 154 can be any movable object that can be controlled by a person or computer. In some embodiments, the vehicle 154 is a car, truck, trailer, scooter, go kart, airplane, helicopter, or any other transportable object. In some embodiments, the vehicle is autonomous and operates with little or no real-time interaction by a human.

In some cases, as shown, the road survey mechanism 100 can be associated with an auto-start sensor 157 for beginning the process of collecting topographical data with the functional components of the road survey mechanism 100. For example, a shaft encoder 160 may be provided for measuring a movement of at least one wheel of the vehicle 154, and a data logger 163 can receive data from the functional components of the road survey system 200 (e.g., from vehicle 154 and/or the road survey mechanism 100, and onboard sensors thereof, etc.). A control computer 166 can be provided for controlling either the vehicle 154 and/or the functional components of the road survey mechanism 100, and a user interface 169 can be provided for allowing a user to interface with the components.

In some cases, the auto-start sensor 157 can provide a signal to the control computer 166 to initiate the collection of data upon the sensing of vehicle movement. For example, the auto-start sensor 157 can be a motion sensor, such as an accelerometer or a Doppler radar sensor, installed within the housing of the vehicle 154 or attached to a chassis of the vehicle 154. Additionally, the auto-start sensor 157 may utilize global positioning data (e.g., GPS data or data from the navigation system) or wheel speed sensors to detect the onset of vehicle motion, ensuring precise synchronization between data collection and vehicle movement.

The shaft encoder 160 can be associated with at least one wheel of the vehicle 154 and can output data indicating a movement amount of the at least one wheel. The shaft encoder 160 can be any device for measuring the movement of at least one wheel of the vehicle 154. For example, the shaft encoder 160 can be an optical encoder that utilizes a rotating disk with slots or markings to generate electrical pulses as the wheel turns, providing precise measurements of distance traveled or rotational position. In some cases, the shaft encoder 160 may employ a magnetic encoder, which utilizes the changes in magnetic field patterns as the wheel rotates to determine motion. Additionally, the shaft encoder 160 could be a mechanical encoder utilizing gears or other mechanical mechanisms to track wheel movement accurately.

The data logger 163 can be communicably coupled to, and store data output by, the plurality of three-dimensional sensors 118, navigation system, front and rear pod cameras 124, 133, and inertial measurement unit 139, and/or various other onboard sensors of the vehicle 154, the road survey mechanism 100, and/or the road survey system 200. The data logger 163 can be any non-transitory computer-readable recording medium capable of recording, storing, and/or organizing data collected by the road survey mechanism 100. For example, the data logger 163 can be a solid-state data storage device such as flash memory, a hard disk drive, or a solid-state drive. Alternatively, the data logger 163 may incorporate wireless communication capabilities to transmit real-time data to a remote server or a computing device for further analysis and processing. The data logger 163 can also feature encryption mechanisms to ensure the security and integrity of the stored surveying data. The data logger 163 can therefore act as a storage associated with the plurality of three-dimensional sensors 118 and inertial measurement unit 139 and can receive data from the plurality of three-dimensional sensors 118 and inertial measurement unit 139.

The control computer 166 can be any computing device capable of directly or indirectly controlling the vehicle 154. For example, the control computer 166 can be a traditional personal computer with desktop or laptop configurations, or a modern handheld device such as a smartphone or tablet. The control computer 166 can include storage for storing data output from the road survey mechanism 100, user selections, an operating system for the control computer 166, applications and services necessary or helpful for the collection of data, or software for controlling the operation of the vehicle 154. The control computer 166 can also include a transceiver for transmitting and receiving data, as well as a processor for executing instructions, performing calculations, managing data flow, and serving as the central component responsible for carrying out computational tasks in the control computer 166. The control computer 166 can also provide the means for communicably coupling the navigation system and inertial measurement unit 139 by analyzing and synchronizing the data output therefrom. In this manner, the control computer 166 can communicably couple the at least one camera 124, 133 to the navigation system and the inertial measurement unit 139.

The user interface 169 can be any component capable of allowing user interaction with the data collected by the road survey mechanism 100 and/or the controls of the road survey mechanism 100. For example, the user interface 169 can be a touchscreen display integrated into the road survey mechanism 100, providing intuitive access to collected surveying data, control settings, and system diagnostics. Alternatively, the user interface 169 may include physical buttons, knobs, or switches along with a liquid crystal display (LCD) screen or light-emitting diode (LED) indicators for displaying relevant information and facilitating user input. Furthermore, the user interface 169 can incorporate audio feedback or voice commands to enhance usability. In some embodiments, the user interface 169 is incorporated into the vehicle 154 as a non-detachable fixture. In other embodiments, the user interface 169 is detachable, and is a tablet, personal computer, smart phone, or any other device capable of collecting user input. The user interface 169 can include navigation instructions, status reporting, error messages or other information necessary or helpful to the operation of the road survey mechanism 100.

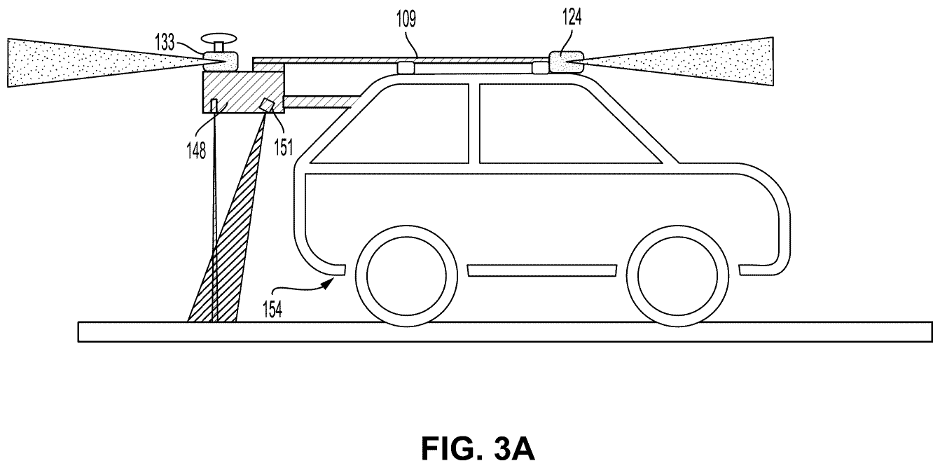

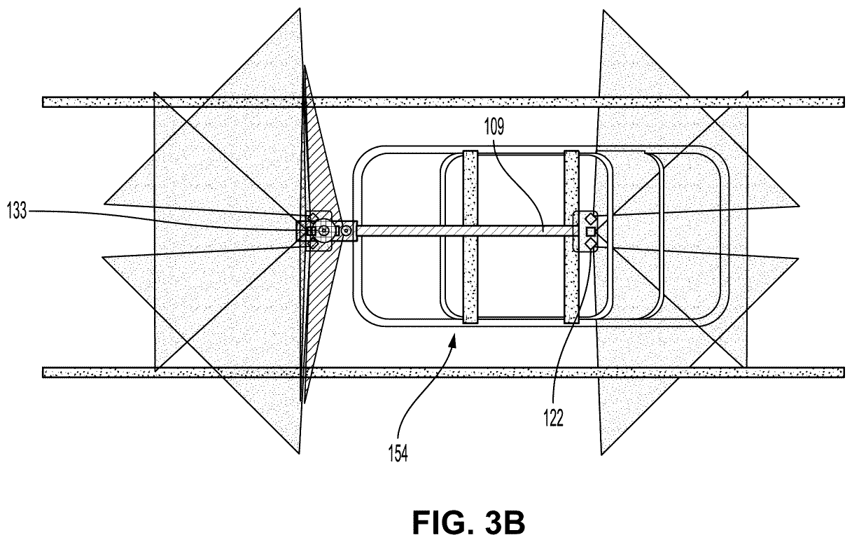

FIG. 3A and FIG. 3B illustrate respective side and top views of a schematic representation of the example road survey system including the road survey mechanism 100 associated with the vehicle 154, in accordance with some examples. For example, as shown, to perform the road survey (e.g., after starting data acquisition corresponding to a configured road survey, etc.) a laser 148 and laser sensor 151 can scan a surface upon which the vehicle 154 travels, for example a road.

For instance, the three-dimensional sensor 118 can include a laser 148 and a laser sensor 151 associated with the laser 148 and capable of receiving an angled reflection of the laser 148 so as to measure the surface upon which the vehicle is moving via laser triangulation. In some cases, laser line triangulation can be used to capture a single transverse profile of the surface (e.g., the road pavement). When combined, these sequential transverse profiles form a three-dimensional pavement surface profile. In some examples, laser triangulation is a technique used for measuring distances or shapes using a laser beam. In some cases, the laser sensor 151 is a camera, and the surface is measured by projecting a laser onto a surface and taking an image of that surface at an angle with the laser sensor 151. By analyzing the image, the distance between the laser source and the surface can be calculated, enabling precise measurements and three-dimensional scanning applications. This two-dimensional image can be taken at regular intervals, and the multiple two-dimensional images can then be “stitched” together during computer processing to form a three-dimensional image.

The laser 148 and laser sensor 151 can be any type of laser 148 and laser sensor 151 capable of carrying out laser triangulation. For example, the laser 148 can be a semiconductor laser diode emitting a narrow and coherent beam with sufficient power and wavelength stability for accurate distance measurements. The laser sensor 151 can be a photodetector or a charge-coupled device (CCD) capable of rapidly capturing the reflected laser light and converting it into precise distance measurements, providing high-resolution surface topography data. In some examples, the laser sensor 151 is a camera.

The front pod camera 124 and rear pod camera 133 can capture images at select intervals. The laser sensor 151 can similarly capture an image of the laser line emitted by the laser 148 at any interval. In an embodiment, the laser sensor 151 captures an image at a rate of approximately 28 KHz. The laser 148 and laser sensor 151 can be coupled to the frame 112 at any position, and in one example may be coupled to the frame 112 at a distance of 1.5 meters above the surface upon which the vehicle 154 travels to allow safe clearance. In some cases, the front pod camera 124 and/or the rear pod camera 133 can be configured to capture images at predefined intervals. For example, the cameras 124, 133 can capture images at predetermined time intervals. In another example, the cameras 124, 133 can capture images every 6 meters (m) based on a distance driven by the vehicle 154 while traveling over the road surface during the performance of the road survey (e.g., as determined by the navigation system and/or the shaft encoder 160 measuring movement of the wheel, etc.). Various other manners of measuring vehicle movement or time can be implemented, for example, by outputting data from the vehicle odometer, visual odometry, or any other method.

As noted previously, existing techniques and approaches to road surveying may use multiple human operators within the road survey vehicle 154, for example where a first operator performs driving tasks associated with the road survey and a second operator performs data collection, acquisition, and/or surveying tasks of the road survey. Systems and techniques are described herein for vehicle-based road survey data acquisition with automatic determination of start and end points for road sections and road segments. For example, the systems and techniques described herein can be used to provide automatic determination of start and end points of road segments that are surveyed by the road survey vehicle 154 and/or the road survey system 200, described previously above. Using the systems and techniques described herein, vehicle-based road surveying operations may be safely and efficiently performed using a single operator (e.g., driver) to drive the road survey vehicle during the road surveying operations.

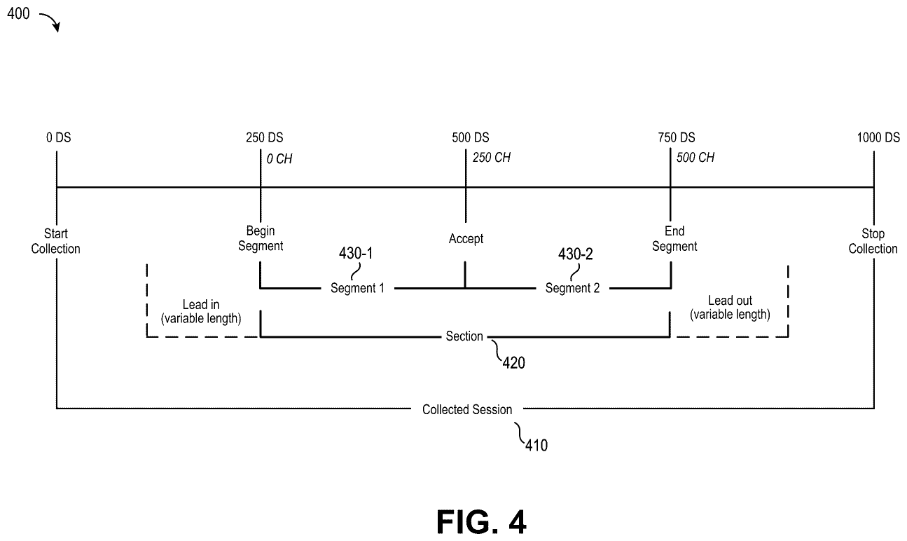

FIG. 4 is a diagram illustrating an example of data acquisition events 400 corresponding to road surveying information indicative of a sequence of target road sections each comprising one or more road segments for a road survey, in accordance with some examples. In some embodiments, the depicted data acquisition events 400 can correspond to road surveying information that is used to configure the road surveying operations performed by the road survey vehicle 154. For example, road surveying information can be obtained to specify the desired portions of a larger road network that are to be surveyed during the road survey operations of the road survey vehicle 154. In some aspects, road surveying information can comprise or otherwise be indicative of a collection of polylines, where each polyline corresponds to a target section or segment of the road network that should be surveyed. Road surveying information may comprise a subset of the plurality of polylines included in a road network definition, or a road network definition file, that corresponds to the larger road network within which the road survey is being performed. For example, the subset of polylines is indicative of the particular road surfaces that are to be surveyed, for example by using the vehicle 154 and onboard sensors and/or road survey mechanism 100 to perform data acquisition to obtain respective road survey data while the vehicle 154 travels over each one of the road surfaces indicated by a polyline included in the subset of polylines. In some aspects, the subset of polylines indicative of the road surfaces to survey can also be referred to as a roadway geometry set to be surveyed.

In one illustrative example, the example data acquisition events 400 depicted in FIG. 4 can also be referred to as road surveying information 400. In some embodiments, a road survey can be performed with one or more collected sessions 410. The collected session 410 (e.g., also referred to herein as a “session”) can correspond to the largest discrete unit of data acquisition that is obtained during the road survey. For example, a collected session (e.g., such as the collected session 410 in the example of FIG. 4) can include all of the road survey data that is acquired from the moment that ‘Start Collection’ is triggered (e.g., shown in FIG. 4 as corresponding to ‘0 DS’) until the moment that ‘Stop Collection’ is triggered (e.g., shown in FIG. 4 as corresponding to ‘1000 DS’).

In some aspects, the various locations or event points shown in FIG. 4 along the horizontal line of the length of the collected session 410 may be expressed in units of ‘DS’ and/or in units of ‘CH’. In one illustrative example, the units ‘DS’ and ‘CH’ can be units of distance. In other examples, the units for specifying data acquisition events 400 may be units of location, position, time, etc. In some embodiments, the unit ‘DS’ shown in FIG. 4 can represent a Distance Stamp, which is calculated as a cumulative quantity or value of the total distance surveyed within the collected session 410. For example, the ‘Start Collection’ trigger that marks the beginning of the collected session 410 can correspond to a Distance Stamp of DS=0. The ‘End Collection’ trigger that marks the end of the collected session 410 can correspond to a Distance Stamp value that is equal to the surveyed length of road during the collected session 410. For example, in FIG. 4, the ‘Stop Collection’ trigger corresponds to a Distance Stamp of DS=1,000, indicating that the collected session 410 corresponds to the road survey vehicle 154 having surveyed a total of 1,000 units (e.g., feet, meters, yards, kilometers, miles, etc.) from the ‘Start Collection’ trigger at DS=0.

In some aspects, ‘CH’ values can represent Chainage, which may be a reference indicator that is independent of the cumulative Distance Stamp values, and for example can be provided within or specified by the corresponding road surveying information or set of polylines used to configure the particular road survey operations for the collected session 410. In some cases, the Chainage values can start from an arbitrary and/or non-zero value, and additionally may increase or decrease over the course of the collected session 410. In other words, the Chainage values do not necessarily increase linearly or cumulatively, and do not necessarily track with the Distance Stamp (DS) values, which do increase linearly and cumulatively with the surveyed distance during the collected session 410.

In some embodiments, a road survey session 410 can include one or more road sections (e.g., also referred to as “target road sections” of the road survey corresponding to the road survey session 410). A target road can be a more granular unit of road surface than the larger road survey session 410. In some aspects, a road network may be divided into a plurality of different road sections. For example, a road network can be divided into a plurality of road sections in which all locators are the same. In the example of FIG. 4, the collected session 410 includes and corresponds to a single target road section 420, although it is noted that a collection session of a road survey may include multiple target road sections. For instance, multiple target road sections can be surveyed within a collection session 410, based on road surveying information indicative of a sequence of target road sections for the road survey. A “sequence” of target road sections may refer to a plurality of target road sections that are surveyed by a road survey vehicle (e.g., vehicle 154) in some sequential order. The sequential order (e.g., the sequence) of the target road sections may be pre-determined or configured, for example by the road surveying information used to configure the vehicle0-based road surveying operations. The sequential order (e.g., the sequence) of target road sections in some embodiments is not pre-determined or pre-configured, and for example can be the sequential surveying order that is chosen or driven by the operator acting as the driver of the road survey vehicle 154.

The target road section 420 comprises a subset of the continuous data acquisition of road survey data that is obtained during the collected session 410 between the ‘Start Collection’ trigger at DS=0 and the ‘Stop Collection’ trigger at DS=1000. For example, data acquisition from the road surveying mechanism 100 may be performed continuously, periodically, intermittently, etc., for the entirety of the duration of the collected session 410, with only a subset of the total data acquisition corresponding to a target road section 420 that is of interest for the road survey. For instance, the data acquisition of the session 410 that occurs after the ‘Start Collection’ trigger at DS=0 but before the beginning of the section 420 at DS=240 can be referred to as a lead in of the data acquisition for the target road section 420. The lead in of the data acquisition for the target road section 420 may have a variable length. Similarly, the data acquisition of the session 410 that occurs after the end of the target road section 420 data collection at DS=750 but before the end of the collected session 410 at DS=1000 can be referred to as a lead out of the data acquisition for the target road section 420. The lead out of the data acquisition for the target road section 420 may have a variable length, which can be the same as or different from the lead in for the same target road section 420 at the beginning portion of the collected session 410.

In some aspects, there may be one or more sessions 410 associated to one section 420. For example, a target road section 420 can be fully contained within a single session 410 (e.g., the target road section 420 is a subset of the single session 410, or is equal to the single session 410), or can span multiple different session (e.g., a first portion of the target road section 420 can be collected within a first session 410, a second portion of the target road section 420 can be collected within a second session 410, a third portion of the target road section can be collected within a third session, . . . , etc.).

A road section (e.g., target road section 420, etc.) may include one or multiple road segments. In some aspects, a road segment (e.g., the first road segment 430-1, second road segment 430-2, . . . , etc.) can comprise a single row entry within a routing file used to specify the road survey operations that are being performed. In other words, a road segment can correspond to a single polyline of the subset of polylines of the road definition file described previously above.

For example, in the example of FIG. 4, the target road section 420 includes a first target road section ‘Segment 1’ 430-1, and a second target road section ‘Segment 2’ 430-2, although it is noted that a target road section 420 can include a greater or lesser number of road segments without departing from the scope of the disclosure. In some aspects, the road segments included within a given target road section can be continuous, such that the end point of one road segment is the same as the start point of the next road segment in the same target road section. In such examples, the total length of the target road section is equal to sum of the individual lengths of the constituent road segments within the target road section. For instance, the target road section 420 and the first road segment 430-1 can have the same start point at DS=250. The target road section 420 and the second road segment 430-2 can have the same end point at DS=750. The transition between the first road segment 430-1 and the second road segment 430-2 can be the same, corresponding to DS=500 being equal to both the end point of the first segment 430-1 and the start point of the second segment 430-2.

In some aspects, the lead in and lead out associated with the target road section 420 can be configured during road survey data import, such that extra data from the data acquisition within the collected session 410 is imported with the chosen length of the respective lead in and lead out parameters, such that any discrepancy at the beginning or end of a section (e.g., target road section 420) may be overcome during segmenting.

As noted previously, the presently disclosed systems and techniques for obtaining automatically detected and determined start and stop points for the road survey data acquisition corresponding to each road segment 430-1, 430-2, . . . , etc., can eliminate or reduce the need to perform manual post-processing of the collected road survey data to correlate the collected data to the individual road segments. The automatic start and stop point detection can additionally reduce or eliminate the need to perform repeated survey operations over a portion of the road segments (e.g., eliminate the need to re-survey road segments where a human operator marked the start point too late and/or marked the end point too early, etc.).

For example, in existing techniques and approaches to vehicle-based road survey data collection, a manual process may be used (e.g., performed by a second human operator within the vehicle 154, in addition to the driver of the vehicle 154) to manually identify and mark each of the respective event points that are depicted in the collection session timeline 400 of FIG. 4. This manual process of marking respective event points during a road survey data acquisition/collection session can correspond to the user manually triggering the ‘Start Collection’ trigger for the session 410 at least 100 meters (m) before the beginning of the target road section 420 having a true starting point location at DS=250, to allow the system to initialize. The user may then manually trigger the ‘Begin Segment’ event start point to mark the beginning of the first segment 430-1 near the true starting point location at DS=250.

If there is only a single segment, the user can subsequently manually trigger the ‘End Segment’ event to mark the end of the section. If there are multiple segments within the section, the user can manually trigger an ‘Accept’ event to mark the end of the previously collected segment (e.g., ‘Accept’ event marks the end of the first segment 430-1), which can both end the previous segment 430-1 and also start the next segment of the section automatically (e.g., ‘Accept’ event also marks the start of the second segment 430-2). Finally, the user will manually trigger the ‘End Collection’ trigger for the session 410 to stop data collection after all target road sections 410 and constituent one or more road segments 430-1, 430-2 for each target road section 410 have been surveyed.

In one illustrative example, the systems and techniques described herein can be used to implement or provide vehicle-based road survey data acquisition with automatic determination of start and end points for road sections and road segments. For example, the systems and techniques can provide automatic determination of the start point at DS=250 corresponding to the starting location for both the target road section 420 and the first segment 430-1 of the road section 420. The systems and techniques can provide automatic determination of the end point at DS=500 corresponding to the ending location for the first segment 430-1, which can be the same as the automatic determination of the start point also at DS=500 corresponding to the starting location for the second segment 430-2. The systems and techniques can additionally provide automatic triggering for starting the road survey data acquisition from the onboard sensors of the vehicle 154 and/or the road surveying mechanism 100, for example corresponding to automatic triggering of data acquisition for the ‘Start Collection’ event of the session 410. The systems and techniques can additionally provide automatic triggering for stopping the road survey data acquisition from the onboard sensors of the vehicle 154 and/or the road surveying mechanism 100, for example corresponding to automatic triggering of the ‘Stop Collection’ event for the session 410.

Using the systems and techniques described herein, vehicle-based road surveying operations may be safely and efficiently performed using a single operator (e.g., driver) to drive the road survey vehicle 154 during the road surveying operations, while data acquisition start and stop point logging is automatically performed.

In some embodiments, each event point described above and depicted in the example data acquisition timeline 400 for the single session 410 of FIG. 4 can be automatically determined based on inputs comprising a current position of the road survey vehicle 154 and/or a current heading of the road survey vehicle 154, along with the road geometry information as specified in the road survey configuration information or set of polylines corresponding to the configured road survey operation being performed.

In some aspects, a current position of the road survey vehicle 154 and/or a current heading of the road survey vehicle 154 can be determined from the same onboard sensors of the road survey vehicle 154 and road survey mechanism 100 that are used to obtain the road survey data. For instance, the current position of the road survey vehicle 154 can be determined from an onboard navigation system of the vehicle 154. As described previously, in some embodiments, the front antenna 121 and/or rear antenna 130 can be an antenna associated with a navigation system (e.g., a vehicle navigation system, an onboard inertial navigation system (INS), etc.) that measures and outputs a global position of the road survey mechanism 100 and/or the road survey vehicle 154 to which the road survey mechanism 100 is coupled. In some examples, the current position of the road survey vehicle 154 can be determined based on the front antenna 121 and/or the rear antenna 130 individually or collectively acting as a navigation system coupled to the frame 112 and configured to measure and output a position of the road survey mechanism 100 at a given time. For example, the navigation system can be a global positioning system (GPS), a global navigation satellite system (GNSS), an inertial navigation system (INS), a radio frequency identification (RFID) navigation system, a dead reckoning navigation system, a visual odometry system, a celestial navigation system, a beacon-based navigation system, a laser-based navigation system, and/or a magnetic navigation system, etc.

In some aspects, a current heading of the road survey vehicle 154 may also be referred to as and/or included within a current orientation information of the road survey vehicle 154. In some embodiments, the current heading/orientation information of the road survey vehicle can be obtained from one or more IMUs, INSs, and/or inertial sensors (e.g., accelerometers, gyroscopes, gyro sensors, magnetic sensors, etc.) that are included as onboard sensors of the road survey vehicle 154 and/or the road survey mechanism 100. For example, the current heading/orientation information for the road survey vehicle 154 can be obtained from the IMU 139, etc.

In some embodiments, sensor data from the same onboard sensors of the vehicle 154 that are used for the data acquisition corresponding to the road survey may also be utilized, at least in part, for automatically detecting the occurrence of various trigger events (e.g., the set of event points 400) for stopping and starting data acquisition at corresponding start and stop points of the various road segments (e.g., road segments 430-1, 430-2, . . . , of FIG. 4, etc.), road sections (e.g., target road section 420 of FIG. 4, etc.), and/or collection sessions (e.g., collection session 410 of FIG. 4, etc.) that are configured for the current road survey.

In one illustrative example, the systems and techniques can obtain sensor data from the onboard sensors of the road survey vehicle 154, where the obtained sensor data is indicative of a current position of the road survey vehicle 154. For example, the current vehicle position can be determined from a GNSS, INS, or other positioning system of the road survey vehicle 154. Sensor data may additionally be obtained indicative of a current heading or orientation of the road survey vehicle 154, for example in the form of accelerometer and/or gyroscopic sensor data obtained from the onboard sensors such as the IMU 139 of the road survey vehicle 154. In some aspects, the position and heading information of the vehicle 154 may be obtained from an INS of the road survey vehicle 154.

In one illustrative example, the automated determination of the corresponding start and end points for marking the individual road sections and/or target road sections within a collection session of road survey data acquisition can be implemented using one or more configured threshold values to control the automated triggering, which are described in turn below.

For example, a Start Collection Tolerance can be configured as a distance in meters, measured from the latest (e.g., current) vehicle 154 position to the first point of the target road section. Based on a determination that the measured distance has fallen below the Start Collection Tolerance threshold value (e.g., distance threshold), all road survey systems can be configured to begin data acquisition from the onboard sensors of the road survey vehicle and/or road surveying mechanism 100. In some aspects, the Start Collection Tolerance can be used to automatically determine the start point to begin data acquisition for the collected session 410 of FIG. 4 (e.g., the ‘Start Collection’ trigger at DS=0 can be based on the Start Collection Tolerance).

In some examples, the distance from the current position of the vehicle 154 to the first point of the target road section (e.g., target road section 420 of FIG. 4) falling below the Start Collection Tolerance can be referred to as the occurrence of a first trigger event. For example, the first trigger event can be a trigger event corresponding to a current position of the vehicle 154 being within a configured threshold distance from a first target road section of the sequence of target road sections, which causes the systems and techniques described herein to automatically start data acquisition from the onboard sensors.

In some embodiments, a Stop Collection Tolerance can be configured as a distance in meters, measured from the latest (e.g., current) position of the road survey vehicle 154 to the last point of the target road section. When the measured distance is larger than the configured Stop Collection Tolerance threshold value, all systems can be configured to cease data acquisition. In some embodiments, the Stop Collection Tolerance threshold can be used to trigger the ‘Stop Collection’ trigger event for ending the collection session 410 at DS=1000 in the example of FIG. 4. In some embodiments, the Stop Collection Tolerance threshold is only used (e.g., distance from current vehicle 154 position to last point of target road section is only evaluated against the Stop Collection Tolerance threshold value) for the last road section in the collection list (e.g., the last target road section included in the sequence of target road sections indicated in the road surveying information that configures the vehicle 154 to perform the road survey).

In some embodiments, evaluating the Stop Collection Tolerance can correspond to determining that a calculated distance between the current position of the vehicle 154 is beyond the configured threshold distance (e.g., Stop Collection Tolerance value) from and an end point of a last target road section in the sequence of target road sections.

In some aspects, a Transit Distance Tolerance can be configured as a distance in meters, measured from the latest (e.g., current) position of the vehicle 154 to the first point of the next target road section included in the sequence of target road sections configured for the road survey by the road surveying information provided to or obtained by the road survey vehicle 154. In some embodiments, if the measured distance from the current position of vehicle 154 to the first point (e.g., start point) of the next target road section does not exceed the Transit Distance Tolerance value, all sections collected so far will be included within the same collection session. If the measured distance from the current position of vehicle 154 to the first point (e.g., start point) of the next target road section does exceed the Transit Distance Tolerance value, the current collection session is stopped and a new collection session will be started when approaching the next road section below the Start Collection Tolerance.

In some examples, an Auto-Match Tolerance can be configured as a distance in meters, measured from the latest (e.g., current) position of the road survey vehicle 154 to one or more different types of event points for a target road section or road segment thereof (e.g., based on each target road section including one or more road segments).

For example, the same Auto-Match Tolerance value can be used for automatically determining the start point of a target road section, triggered when the distance from the current vehicle 154 position to the configured/indicated location of the next target road section falls below the Auto-Match Tolerance value.

In another example, the same Auto-Match Tolerance value can be used for automatically determining the end point of a target road section, triggered when the distance from the current vehicle 154 position to the configured/indicated ending location of the current target road section exceeds the Auto-Match Tolerance value. In some cases, the end point of a target road section is triggered or automatically determined based on the distance between the vehicle 154 current position and the configured/indicated ending location of the current target road sections increases above the Auto-Match Tolerance value after previously falling below the Auto-Match Tolerance value.

In some aspects, the same Auto-Match Tolerance value is additionally used for automatically determining the start point of a road segment, triggered when the distance from the current vehicle 154 position to the configured/indicated starting location of the next road segment falls below the Auto-Match Tolerance value. In some aspects, triggering the start point of a next road segment can additionally include automatically triggering or determining the end point of the currently surveyed road segment, based on road segments that are configured or defined in the road network definition file as adjacent or touching polylines, etc.

In some cases, the various evaluations automatically performed based on the Auto-Match Tolerance value and a calculated distance between the current position of the road survey vehicle 154 and a configured/indicated ground truth event point location of a polyline or road network definition file object (e.g., ground truth starting location of a target road section, ground truth ending location of a target road section, ground truth starting location of a road segment, etc.), can be referred to as the occurrence of a second trigger event.

In some embodiments, a Start Section Heading Tolerance can be configured as an angular offset value (e.g., in degrees, etc.), which may be applied as an offset to the start heading of the next target road section. For example, the Start Section Heading Tolerance can be used to detect the occurrence of a third trigger event, corresponding to the difference between the current heading or orientation of the road survey vehicle 154 and the start heading of the next target road section being less than or equal to the configured Start Section Heading Tolerance offset value. For example, if the Start Section Heading Tolerance offset value is equal to 15 degrees, for a next target road section with a start heading of 120 degrees, the occurrence of the third trigger event is detected automatically when the current heading of the road survey vehicle 154 is detected as being within ± the Start Section Heading Tolerance offset of 15 degrees from the section start heading of 120 degrees (e.g., third trigger event detected when the current vehicle 154 heading is between 105-135 degrees, etc.).

In some embodiments, the start of a target road section can be detected as a two-stage or two-step process. For example, the start of a target road section may be successfully detected based on first determining that the current heading of the vehicle 154 is within the Start Section Heading Tolerance offset from the start heading of the target road section (e.g., occurrence of the third trigger event detected). The second determination can correspond to determining that the current position of the vehicle 154 is within the Auto-Match Tolerance distance from the true starting location of the same target road section (e.g., occurrence of the second trigger event detected after the occurrence of the third trigger event). In one illustrative example, the Auto-Match Tolerance can be ignored at the start of a target road section, until it is determined that the road survey vehicle 154 has a current heading that matches (e.g., is within the Start Section Heading Tolerance) the target road section start heading. In some aspects, detecting the occurrence of the second trigger event (e.g., evaluating the position of vehicle 154 against the Auto-Match Tolerance distance to the start of the road section or segment) is skipped based on having determines that the third trigger event has not occurred (e.g., the heading of vehicle 154 is not yet within the Start Section Heading Tolerance offset from the start heading of the target road section).

In some aspects, the systems and techniques described herein can increase the efficiency of road survey operations by collecting less road survey data as compared to the existing approach of manually triggering and detecting each event point occurrence or location within the data acquisition performed for a collection session of the road survey. For instance, in existing techniques that use two human operators in the road survey vehicle, the manually marked start and stop points of a road segment are often initiated earlier than the true start point (e.g., in an attempt to avoid a ‘missed’ marker point where the manually marked start point is later than or after the true start point of the road segment), and are ended later than the true end point (e.g., in an attempt to avoid another type of ‘missed’ marker point where the manually marked end point is prior to or before the true end point of the road segment), etc.

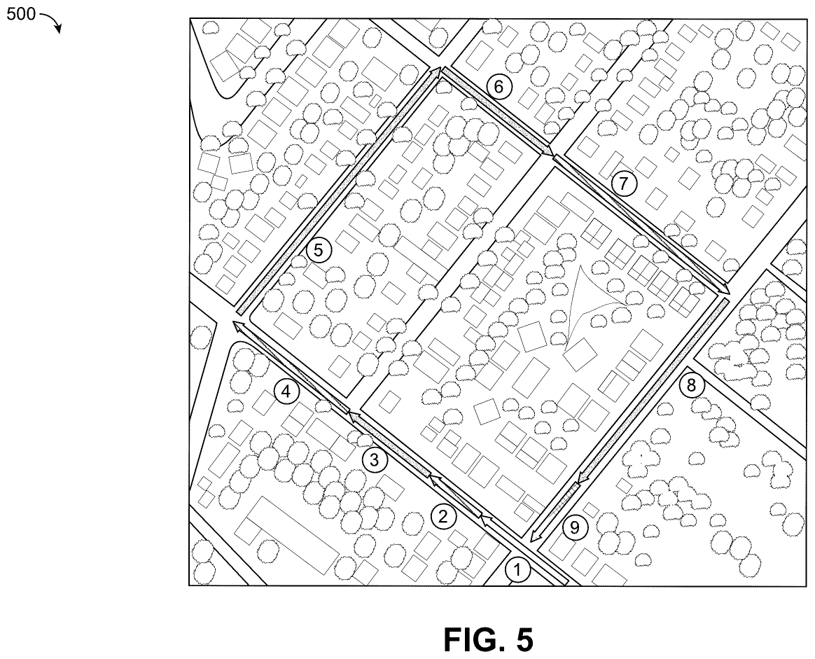

FIG. 5 is a diagram illustrating an example of data acquisition events 500 corresponding to automatically determined corresponding start points and end points for each road segment of a plurality of road segments included in a sequence of target road sections for a road survey, in accordance with some examples. For instance, the data acquisition events 500 can correspond to the nine data acquisition events 1-9, each labeled in the example of FIG. 5 within a respective circle. In some aspects, the data acquisition events 500 can correspond to the example data acquisition events 1-9, presented in Table 1 and further described below.

TABLE 1
Example data acquisition events corresponding to target
road sections and/or road segments of a road survey.

| Event Number | Status | Configuration |
|---|---|---|
| 1 | Standby | Standby status. Sensors not |
| | | collecting. |
| 2 | Systems On | Sensors collecting. Not on a |
| | | segment/section |
| 3 | Collecting | Sensors collecting. On a |
| | | segment/section. |
| 4 | Systems On | Sensors collecting. Not on a |
| | | segment/section |
| 5 | Collecting | Sensors collecting. On a |
| | | segment/section. |
| 6 | Collecting | Sensors collecting. On a |
| | | segment/section. |
| 7 | Systems On | Sensors collecting. Not on a |
| | | segment/section. |
| 8 | Collecting | Sensors collecting. On a |
| | | segment/section |
| 9 | Segment Ended | Sensors not collecting. Not on a |
| | | segment/section |

Data Acquisition Event 1—“Standby”: The road survey vehicle 154 is associated with a ‘Standby’ status. In the Standby status, the onboard sensors of the road survey vehicle 154 and the road surveying mechanism 100 are not collecting, and the road survey vehicle 154 is not determined as being on a configured target road section or road segment included in a target road section for the road survey. For example, the Standby status can correspond to times prior to the ‘Start Collection’ trigger at DS=0 of FIG. 4.

Data Acquisition Event 2—“Collection Started”: The road survey vehicle 154 is associated with a ‘Systems On’ status. In the Systems On status, the onboard sensors of the road survey vehicle 154 and the road surveying mechanism 100 are collecting (e.g., data acquisition has been started and is performed in a continuous or ongoing manner), but the road survey vehicle 154 has not been detected as being on a configured target road section or road segment included in a target road section for the road survey.

For example, Data Acquisition Event 2 can correspond to the time between the ‘Start Collection’ trigger at DS=0 of FIG. 4 and the ‘Begin Segment’ trigger at DS=250 of FIG. 4. In other words, Data Acquisition Event 2 can comprise trigger or detecting the start of the collection session 410 of FIG. 4, for example based on the Start Collection Tolerance.

In one illustrative example, the entry to Data Acquisition Event 2 can be triggered by detecting that the distance from the current position of the road survey vehicle 154 to the configured/indicated starting location of the section has fallen below the Start Collection Tolerance.

Data Acquisition Event 3—“Segment Started”: The road survey vehicle 154 is associated with a ‘Collecting’ status. In the Collecting status, the onboard sensors of the road survey vehicle 154 and the road surveying mechanism 100 are collecting (e.g., data acquisition has been started and is performed in a continuous or ongoing manner), and the road survey vehicle 154 has additionally been detected as being on a particular one of the configured target road sections or road segments included in a target road section for the road survey. In this case, the collected data acquisition information can be referred to as a respective road survey data, which the road survey vehicle 154 automatically associates to the particular target road section or road segment that was identified at the entry to Data Acquisition Event 3 (for example based on one or more of the Auto-Match Tolerance, and/or the Start Section Heading Tolerance).

In one illustrative example, the entry to Data Acquisition Event 3 can be triggered by a determination that the distance from the current position of the road survey vehicle 154 to the start of the target road section has fallen below the Auto-Match Threshold distance after previously determining that the current heading of the road survey vehicle 154 matches to the start heading of the target road section within the Start Section Heading Tolerance.

Data Acquisition Event 4—“Segment Ended”: The road survey vehicle 154 is associated with a ‘Systems On’ status. In the Systems On status, the onboard sensors of the road survey vehicle 154 and the road surveying mechanism 100 are collecting (e.g., data acquisition has been started and is performed in a continuous or ongoing manner), but the road survey vehicle 154 has not been detected as being on a configured target road section or road segment included in a target road section for the road survey. In some examples, the entry to Data Acquisition Event 4 can be the same as the exit from Data Acquisition Event 3.

In one illustrative example, Data Acquisition Event 4 corresponds to automatically determining that the distance from the road survey vehicle 154 to the configured/indicated ending location of the target road section has risen above the Auto-Match Threshold distance. Data collection continues for the collection session, but is not ‘matched’ with any particular target road section or road segment of the configured road survey operation. Alternatively, if the distance from the end of the section to the start of the next is greater than the Transit Tolerance, the current collection session is ended and data acquisition is stopped. Data acquisition would then be started again, for a new collection session beginning while the road survey vehicle 154 is approaching the next section (e.g., new collection session starts and data acquisition started again when the road survey vehicle 154 position next is within the Start Collection Tolerance distance).

Data Acquisition Event 5—“Segment Started”: May be the same as or similar to the Data Acquisition Event 3 described above.

The road survey vehicle 154 is associated with a ‘Collecting’ status. In the Collecting status, the onboard sensors of the road survey vehicle 154 and the road surveying mechanism 100 are collecting (e.g., data acquisition has been started and is performed in a continuous or ongoing manner), and the road survey vehicle 154 has additionally been detected as being on a particular one of the configured target road sections or road segments included in a target road section for the road survey. In this case, the collected data acquisition information can be referred to as a respective road survey data, which the road survey vehicle 154 automatically associates to the particular target road section or road segment that was identified at the entry to Data Acquisition Event 3 (for example based on one or more of the Auto-Match Tolerance, and/or the Start Section Heading Tolerance).

Data Acquisition Event 6—“On Segment”: (no change)

Data Acquisition Event 7—“Segment Ended”: May be the same as or similar to Data Acquisition Event 4, described above.

The road survey vehicle 154 is associated with a ‘Systems On’ status. In the Systems On status, the onboard sensors of the road survey vehicle 154 and the road surveying mechanism 100 are collecting (e.g., data acquisition has been started and is performed in a continuous or ongoing manner), but the road survey vehicle 154 has not been detected as being on a configured target road section or road segment included in a target road section for the road survey.

Data Acquisition Event 8—“Segment Started”: May be the same as or similar to Data Acquisition Event 3, described above.

The road survey vehicle 154 is associated with a ‘Collecting’ status. In the Collecting status, the onboard sensors of the road survey vehicle 154 and the road surveying mechanism 100 are collecting (e.g., data acquisition has been started and is performed in a continuous or ongoing manner), and the road survey vehicle 154 has additionally been detected as being on a particular one of the configured target road sections or road segments included in a target road section for the road survey. In this case, the collected data acquisition information can be referred to as a respective road survey data, which the road survey vehicle 154 automatically associates to the particular target road section or road segment that was identified at the entry to Data Acquisition Event 3 (for example based on one or more of the Auto-Match Tolerance, and/or the Start Section Heading Tolerance).

Data Acquisition Event 9—“Segment Ended”: In response to a determination that the road survey vehicle 154 has traveled farther than (e.g., beyond) the Stop Collection Tolerance from the configured/indicated ending location of the last target road section, the current collection session will end automatically and the data acquisition ceases (e.g., corresponding to the ‘Stop Collection’ trigger event at the end of collection session 410 at DS=1000 of FIG. 4).

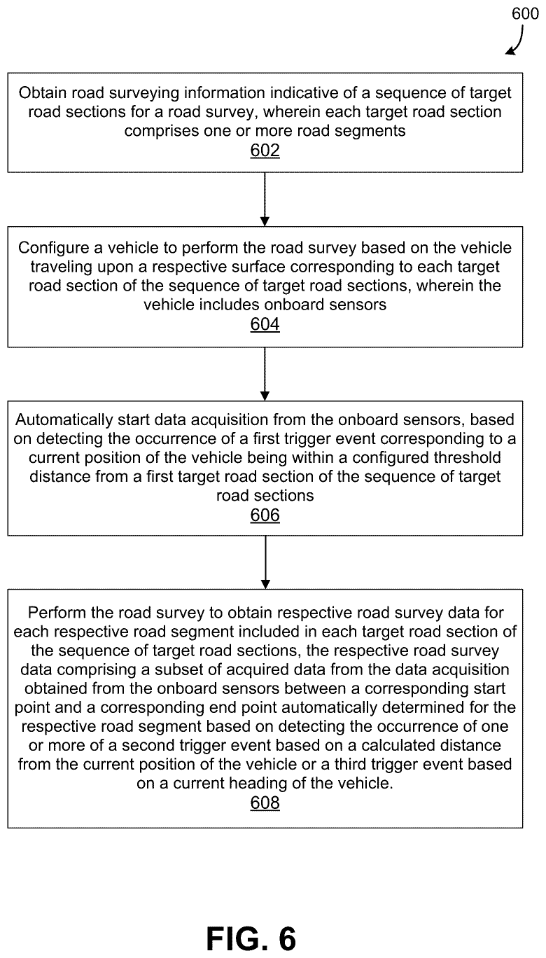

FIG. 6 is a flowchart diagram illustrating an example of a process 600 for road surveying. For example, the process 600 can correspond to road surveying using automatically detected and determined corresponding start and end points for each road segment of a plurality of road segments included in a sequence of target road sections for the road survey, in accordance with some examples. In one illustrative example, the process 600 can be implemented by a vehicle that includes, integrated, and/or is coupled to a road surveying mechanism. For example, the process 600 can be implemented by a vehicle (e.g., road survey vehicle, road profiler vehicle, road profiler, etc.) that is the same as or similar to the vehicle 154 of FIGS. 2-3B, etc. The process 600 can be implemented by a vehicle that includes a road surveying mechanism that is the same as or similar to the road surveying mechanism 100 of FIGS. 1-3B. In some aspects, the process 600 can be implemented by the road survey system 200 of FIG. 2.

In some aspects, at block 602, the process 600 can include obtaining road surveying information indicative of a sequence of target road sections for a road survey, wherein each target road section comprises one or more road segments. At block 604, the process 600 can include configuring a vehicle to perform the road survey based on the vehicle traveling upon a respective surface corresponding to each target road section of the sequence of target road sections, wherein the vehicle includes onboard sensors. At block 606, the process 600 can include automatically starting data acquisition from the onboard sensors, based on detecting the occurrence of a first trigger event corresponding to a current position of the vehicle being within a configured threshold distance from a first target road section of the sequence of target road sections. At block 608, the process 600 can include performing the road survey to obtain respective road survey data for each respective road segment included in each target road section of the sequence of target road sections, the respective road survey data comprising a subset of the data acquisition obtained from the onboard sensors between a corresponding start point and a corresponding end point automatically determined for the respective road segment based on detecting the occurrence of one or more of a second trigger event based on a calculated distance from the current position of the vehicle or a third trigger event based on a current heading of the vehicle.

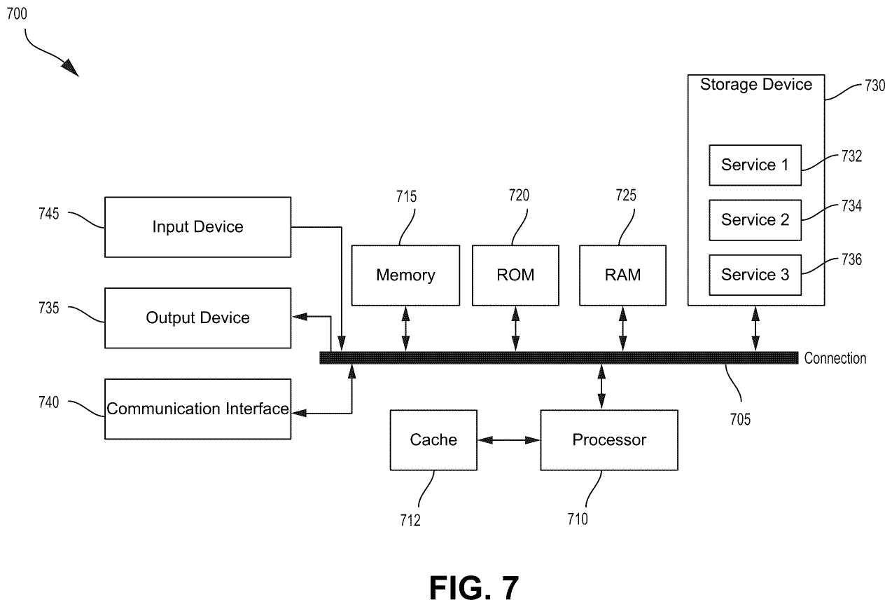

The operations of the process 600 may be implemented as software components that are executed and run on one or more processors (e.g., processor 710 of FIG. 7 or other processor(s)). In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 600 is illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 600 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 is a diagram illustrating an example of a system for implementing certain aspects of the present technology. In particular, FIG. 7 illustrates an example of computing system 700, which may be for example any computing device making up internal computing system, a remote computing system, a camera, or any component thereof in which the components of the system are in communication with each other using connection 705. Connection 705 may be a physical connection using a bus, or a direct connection into processor 710, such as in a chipset architecture. Connection 705 may also be a virtual connection, networked connection, or logical connection.

In some aspects, computing system 700 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 700 includes at least one processing unit (CPU or processor) 710 and connection 705 that communicatively couples various system components including system memory 715, such as read-only memory (ROM) 720 and random access memory (RAM) 725 to processor 710. Computing system 700 may include a cache 715 of high-speed memory connected directly with, in close proximity to, or integrated as part of processor 710.

Processor 710 may include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms. In some instances, multimodal systems may enable a user to provide multiple types of input/output to communicate with computing system 700.

Computing system 700 may include communications interface 740, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 730 may include software services, servers, services, etc., that when the code that defines such software is executed by the processor 710, it causes the system to perform a function. In some aspects, a hardware service that performs a particular function may include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

1. A method comprising:
obtaining road surveying information indicative of a sequence of target road sections for a road survey, wherein each target road section comprises one or more road segments;
configuring a vehicle to perform the road survey based on the vehicle traveling upon a respective surface corresponding to each target road section of the sequence of target road sections, wherein the vehicle includes onboard sensors;
based on detecting the occurrence of a first trigger event corresponding to a current position of the vehicle being within a configured threshold distance from a first target road section of the sequence of target road sections, automatically starting data acquisition from the onboard sensors; and
between a corresponding start point and a corresponding end point, automatically determined for the respective road segment, performing the road survey to obtain respective road survey data for each respective road segment included in each target road section of the sequence of target road sections, the respective road survey data comprising a subset of acquired data from the data acquisition obtained from the onboard sensors based on detecting the occurrence of one or more of a second trigger event based on a calculated distance from the current position of the vehicle or a third trigger event based on a current heading of the vehicle.

2. The method of claim 1, further comprising:
determining that the current position of the vehicle is beyond the configured threshold distance from an end point of a last target road section in the sequence of target road sections; and
ending the data acquisition from the onboard sensors.

3. The method of claim 2, wherein ending the data acquisition from the onboard sensors corresponds to completing the road survey for the sequence of target road sections indicated in the road surveying information.

4. The method of claim 1, wherein determining the corresponding start point for each respective road segment includes:
determining that an angular offset between the current heading of the vehicle and a pre-determined starting heading of the respective road segment is less than a configured heading threshold value; and
determining that the current position of the vehicle is within a configured distance threshold from a pre-determined start location of the respective road segment.

5. The method of claim 4, wherein:
determining the angular offset is less than the configured heading threshold value comprises the third trigger event; and
determining the current position of the vehicle is within the configured distance threshold comprises the second trigger event.

6. The method of claim 1, wherein determining the corresponding start point for each respective road segment is based on detecting the occurrence of the second trigger event and the third trigger event.

7. The method of claim 1, wherein detecting the occurrence of the second trigger event is performed based on previously having detected the occurrence of the third trigger event.

8. The method of claim 7, wherein detecting the occurrence of the second trigger event is skipped based on a determination the third trigger event has not occurred.

9. The method of claim 1, wherein determining the corresponding end point for each respective road segment includes:
determining that a calculated distance between the current position of the vehicle and a pre-determined ending location of the respective road segment is greater than a configured distance threshold value.

10. The method of claim 9, wherein determining the calculated distance is greater than the configured distance threshold value comprises the second trigger event.

11. The method of claim 1, wherein:
the corresponding start point for the respective road segment is determined based on a distance from the current position of the vehicle to a pre-determined starting location of the respective road segment being within a second configured threshold distance; and
the corresponding end point for the respective road segment is determined based on a distance from the current position of the vehicle to a pre-determined ending location of the respective road segment exceeding the second configured threshold distance.

12. The method of claim 11, wherein:
the road surveying information is indicative of a pre-determined ending location for each target road section in the sequence of target road sections; and
the pre-determined ending location for each target road section is the same as the pre-determined ending location for a respective last road segment included in each target road section.

13. The method of claim 1, wherein the current position of the vehicle and the current heading of the vehicle are obtained from one or more of the onboard sensors after starting the data acquisition to perform the road survey.

14. The method of claim 1, wherein the current position of the vehicle and the current heading of the vehicle are obtained from an inertial navigation system (INS) included in the onboard sensors.

15. The method of claim 1, wherein the vehicle is a road profiler vehicle or a road survey vehicle configured to perform the road survey based on the road surveying information.

16. The method of claim 1, wherein:
the sequence of target road sections comprises a plurality of target road sections arranged in a sequential order for performing the road survey; and
the road surveying information comprises a road network definition file.

17. The method of claim 16, wherein:
the plurality of target road sections corresponds to a plurality of road segments, wherein a quantity of the plurality of road segments is greater than or equal to a quantity of the plurality of target road sections; and
the road surveying information includes a plurality of polylines, and wherein each polyline of the plurality of polylines corresponds to a different road segment of the plurality of road segments.

18. A system comprising:
at least one processor; and
a memory storing instructions which when executed by the at least one processor, causes the at least one processor to:
obtain road surveying information indicative of a sequence of target road sections for a road survey, wherein each target road section comprises one or more road segments;
configure a vehicle to perform the road survey based on the vehicle traveling upon a respective surface corresponding to each target road section of the sequence of target road sections, wherein the vehicle includes onboard sensors;
based on detecting the occurrence of a first trigger event corresponding to a current position of the vehicle being within a configured threshold distance from a first target road section of the sequence of target road sections, automatically start data acquisition from the onboard sensors; and
perform the road survey to obtain respective road survey data for each respective road segment included in each target road section of the sequence of target road sections, the respective road survey data comprising a subset of acquired data from the data acquisition obtained from the onboard sensors between a corresponding start point and a corresponding end point automatically determined for the respective road segment based on detecting the occurrence of one or more of a second trigger event based on a calculated distance from the current position of the vehicle or a third trigger event based on a current heading of the vehicle.

19. The system of claim 18, wherein:
detecting the occurrence of the third trigger event comprises determining that an angular offset between the current heading of the vehicle and a pre-determined starting heading of the respective road segment is less than a configured heading threshold value; and
detecting the occurrence of the second trigger event comprises determining that the current position of the vehicle is within a configured distance threshold from a pre-determined start location of the respective road segment.

20. The system of claim 18, wherein:
the corresponding start point for the respective road segment is determined based on a distance from the current position of the vehicle to a pre-determined starting location of the respective road segment being within a second configured threshold distance; and
the corresponding end point for the respective road segment is determined based on a distance from the current position of the vehicle to a pre-determined ending location of the respective road segment exceeding the second configured threshold distance.
